(19) United States
(12) Patent Application Publication
(10) Pub. No.: US 2007/0285379 A1
(43) Pub. Date: Dec. 13, 2007

(54) Liquid crystal display and method of adjusting brightness for the same

(75) Inventors: Jun-ho Jung, Seoul (KR); Hanfeng Chen, Suwon-si (KR); Chang-wan Hong, Yongin-si (KR); Yung-jun Park, Yongin-si (KR); Jun-ho Sung, Seoul (KR); Hoon Choi, Suwon-si (KR); Ki-bum Seong, Anyang-si (KR); Hyung-rae Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/655,257

(22) Filed: Jan. 19, 2007

(30) Foreign Application Priority Data
Jun. 9, 2006 (KR) 10-2006-0051999
Aug. 17, 2006 (KR) 10-2006-0077771

(51) Int. Cl. G09G 3/36

(52) U.S. Cl. 345/102

(57) ABSTRACT

A liquid crystal display (LCD) and method of adjusting brightness for the LCD are provided. The LCD includes a light emitter including a plurality of luminescent bodies which are divided into a predetermined number of partial areas, a backlight driver connected to the light emitter to control the brightness of each of the partial areas of the light emitter, and a controller for calculating a representative value for adjusting the brightness of each of the partial areas of the light emitter in accordance with an input image signal and outputting the representative value as a brightness adjustment signal for adjusting the brightness of each of the partial areas to the backlight driver. Thus, the brightness of each of partial areas of a backlight can be adjusted in accordance with the input image signal to improve a contrast ratio. Also, a representative value to be used for adjusting the brightness of each of the partial areas can be lowered by a predetermined ratio to effectively reduce power needed for lighting the backlight. Also, light loss and light gain occurring between neighboring partial areas can be compensated to improve the contrast ratio, and image artifacts can be reduced.

### CROSS-REFERENCE TO RELATED APPLICATIONS

This application claims the benefit under 35 U.S.C. §119(a) of Korean Patent Application No. 10-2006-0051999 filed Jun. 9, 2006 in the Korean Intellectual Property Office, and Korean Patent Application No. 10-2006-0077771, filed Aug. 17, 2006 in the Korean Intellectual Property Office, the entire disclosures of which are hereby incorporated by reference.

### BACKGROUND OF THE INVENTION

1. Field of the Invention

The present invention relates to a liquid crystal display (LCD) and a method of adjusting brightness for the same. More particularly, the present invention relates to an LCD that is capable of adjusting the brightness of each of the partial areas of a backlight in accordance with an input image signal so as to improve a contrast ratio, and effectively reduce power needed for lighting the backlight by lowering a representative value to be used to adjust the brightness of each of the partial areas by a predetermined ratio, and a method for implementing the same.

2. Description of the Related Art

In general, liquid crystal displays (LCDs) are used for televisions (TVs), notebook computers, desktop computers or the like, in order to display images. Since liquid crystals used for such LCDs are not able to generate light by themselves, the LCDs must use light emitted from additional light sources. Thus, the LCDs are provided with backlights for forming light sources on rear surfaces of liquid panels and thereby display images by adjusting the transmissivity of light emitted from the backlights depending on movements of the liquid crystals.

Conventional uniform backlights supply uniform light to LCD panels. However, dark images (for example, those having pixel values of “0”) are not completely represented due to loss of light incident on the liquid panels. Thus, the contrast ratio is remarkably lowered.

Also, conventional uniform backlights have limits in reproducing full colors on the screens by adjusting the brightness of screens in accordance with image signals. For example, an image such as a fireworks display scene or an explosion scene includes a portion requiring a high brightness. However, there is no appropriate compensation method for the image. Thus, it is difficult to vividly represent the image. Therefore, this demand has resulted in methods for brightly representing a specific portion of a screen and darkly representing another specific portion to improve a contrast ratio so as to represent a clear, vivid image.

Also, conventional uniform backlights use the same backlight brightness for dark images or bright images. Thus, power needed for lighting the backlight is wasted in partial areas of conventional backlights corresponding to dark or less-bright images which can be sufficiently displayed with a low brightness.

In addition, even if the backlight is divided into partial areas and is capable of adjusting each of the partial areas so that an image having a partially high brightness can be effectively represented, light loss and light gain occur due to an interaction between neighboring partial areas. Thus, light loss and light gain must be compensated, and image artifacts generated depending on a movement degree of the image must be reduced.

Accordingly, a need exists for a system and method for adjusting the brightness of each of the partial areas of a backlight in accordance with an input image and further minimize undesired light loss, light gain and image artifacts.

### SUMMARY OF THE INVENTION

Exemplary embodiments of the present invention are provided to address at least the above problems and/or disadvantages, and provide at least the advantages described below. Accordingly, an aspect of embodiments of the present invention is to provide an LCD that is capable of adjusting the brightness of each of the partial areas of a backlight in accordance with an input image signal so as to improve a contrast ratio and effectively reduce power needed for lighting the backlight by lowering a representative value to be used to adjust the brightness of each of the partial areas by a predetermined ratio, and a method for adjusting the brightness for implementing the same.

Another aspect of embodiments of the present invention is to provide an LCD that is capable of compensating light loss and light gain occurring between neighboring partial areas thereby improving a contrast ratio, and reducing image artifacts, and a method of adjusting the brightness for the LCD for implementing the same.

According to an exemplary aspect of embodiments of the present invention, an LCD is provided, comprising a light emitter comprising a plurality of luminescent bodies which are divided into a predetermined number of partial areas, a backlight driver connected to the light emitter to control the brightness of each of the partial areas of the light emitter, and a controller for calculating a representative value for adjusting the brightness of each of the partial areas of the light emitter in accordance with an input image signal and outputting the representative value as a brightness adjustment signal for adjusting the brightness of each of the partial areas to the backlight driver.

Preferably, according to an exemplary aspect of embodiments of the present invention, the controller can filter and output the brightness adjustment signal.

Preferably, according to an exemplary aspect of embodiments of the present invention, the filtering can be spatial filtering and/or temporal filtering.

Preferably, according to an exemplary aspect of embodiments of the present invention, the controller can classify pixels of each of the partial areas into the number of pixels according to each gray level in accordance with an input image signal and calculate the representative value to be used to adjust the brightness of each of the partial areas by using the number of pixels of each of the sections which are made by dividing gray levels at predetermined intervals and a mean value of the gray levels of each section.

According to an exemplary aspect of embodiments of the present invention, the representative value can be calculated using Equation (1) below:

$$L = f ( L\_Thr * ( {{N}_{0} ( \frac{{M}_{0}}{256} )}^{2} + {{N}_{1} ( \frac{{M}_{1}}{256} )}^{2} + {{N}_{2} ( \frac{{M}_{2}}{256} )}^{2} + {{N}_{3} ( \frac{{M}_{3}}{256} )}^{2} + {{N}_{4} ( \frac{{M}_{4}}{256} )}^{2} + {{N}_{5} ( \frac{{M}_{5}}{256} )}^{2} + {{N}_{6} ( \frac{{M}_{6}}{256} )}^{2} + {{N}_{7} ( \frac{{M}_{7}}{256} )}^{2} ) ) \qquad ( 1 )$$

wherein L_Thr denotes a coefficient for compensating the brightness of each of the partial areas, Mn(n=0, 1, 2, . . . ) denotes a mean value of the gray levels of a section n, and Nn(n=0, 1, 2, . . . ) denotes the number of pixels of the section n.

Preferably, according to an exemplary aspect of embodiments of the present invention, if the mean brightness of the entire input image signal is lower than a predetermined threshold value, a partial area of which the representative value is greater than the mean brightness of the entire input image is applied with a new representative value L′ which has been compensated by using Equation (2) below in order to adjust the brightness of the partial area:

L′=L+BEN*(L−mean) (2)

wherein L′ denotes the new representative value of a partial area of which the brightness loss has been compensated, L denotes a representative value before being compensated, BEN denotes a coefficient for compensating the brightness, and mean denotes the mean brightness of an entire input image.

Preferably, according to an exemplary aspect of embodiments of the present invention, the controller can adjust the brightness of the light emitter at the same speed as a speed at which the input image signal is processed in synchronization with the input image signal.

Also, preferably, according to an exemplary aspect of embodiments of the present invention, the controller can adjust the brightness of the light emitter at a speed that is different from a speed at which the input image signal is processed.

According to an exemplary aspect of embodiments of the present invention, a method of calculating a representative value for adjusting the brightness of each of the partial areas of a light emitter in accordance with an input image signal is provided, comprising outputting the calculated representative value as a brightness adjustment signal and adjusting the brightness of each of the partial areas based on the brightness adjustment signal.

According to another exemplary aspect of embodiments of the present invention, an LCD is provided, comprising a backlight unit comprising a light emitter which is divided into a predetermined number of partial areas so that the brightness of each of the partial areas can be adjusted, an LCD unit comprising an LCD panel and an LCD driver, and a controller for calculating a representative value to be used for adjusting the brightness of each of the partial areas in accordance with an input image signal, lowering the representative value by a predetermined ratio to reduce power needed for lighting the backlight, and outputting the lowered representative value to the backlight unit.

Preferably, according to an exemplary aspect of embodiments of the present invention, the predetermined ratio can be calculated using Equation (3) below:

R=A/(A+T_{—}Thr*(255−A)) (3)

wherein R denotes the predetermined ratio, A denotes a cut-off gray level, i.e., a maximum gray level of image pixels corresponding to a partial area wherein white Gaussian noise is excluded, and T_Thr denotes a predetermined threshold value within a range between “0” and “1.”

Preferably, according to an exemplary aspect of embodiments of the present invention, the cut-off gray level A can satisfy Equation (4) below:

$${\sum }_{g = 0}^{A} H ( g ) \geq Cut\_Thr , and {\sum }_{g = 0}^{A - 1} H ( g ) < Cut\_Thr \qquad ( 4 )$$

wherein g denotes a gray level, H(g) denotes the total number of pixels corresponding to “0” through “g”, and Cut_Thr denotes a predetermined threshold value allowing a large number of pixels to belong to gray levels “0” through “A.”

Preferably, according to an exemplary aspect of embodiments of the present invention, the controller can multiply gray levels of image pixels corresponding to each of the partial areas by “1/R” or “(1/R)^{1/γ}” to compensate for the reduction in the brightness of the backlight unit caused by the lowered representative value so that the brightness of an image to be displayed can be adjusted.

Preferably, according to an exemplary aspect of embodiments of the present invention, the controller can perform spatial filtering of the representative value, maintaining the brightness of the partial area of which the brightness is the maximum among the partial areas.

According to an exemplary aspect of embodiments of the present invention, the controller can temporal filter the representative value using Equation (5) below:

Lₒᵤₜ⁽ⁿ⁾(k)=P′·L_{ST}⁽ⁿ⁾(k)+(1−P′)·Lₒᵤₜ⁽ⁿ⁻¹⁾(k) (5)

wherein P′ denotes a predetermined threshold value for filtering and P′=min(P+S, 1), where P=|Mean_P−Mean_C|/256 and S=|Mean_P−Mean_C|/256, Lₒᵤₜ⁽ⁿ⁾(k) denotes the final output brightness of a k^{th} partial area of a current frame after filtering, L_{ST}⁽ⁿ⁾(k) denotes the brightness of the k^{th} partial area of the current frame, Lₒᵤₜ⁽ⁿ⁻¹⁾(k) denotes the final output brightness of a k^{th} partial area of a previous frame, P denotes frame brightness variation, S denotes a partial area's brightness variation, Mean_P denotes the mean brightness of pixels of the previous frame, and Mean_C denotes the mean brightness of pixels of the current frame.

According to another exemplary aspect of embodiments of the present invention, a method of calculating a representative value for adjusting the brightness of each of the partial areas of a light emitter in accordance with an input image signal is provided, comprising lowering the representative value by a predetermined ratio to reduce power needed for lighting the backlight, and outputting the lowered representative value to a backlight unit to apply the lowered representative value so as to adjust the brightness of each of the partial areas.

### BRIEF DESCRIPTION OF THE DRAWINGS

The above and other objects, features and advantages of embodiments of the present invention will become more apparent from the following description taken in conjunction with the accompanying drawings, in which:

FIG. 1 is a schematic block diagram illustrating a structure of a liquid crystal display (LCD) according to an exemplary embodiment of the present invention;

FIG. 2 is a histogram illustrating a method of calculating a representative value of each of the partial areas according to an exemplary embodiment of the present invention;

FIG. 3 is a graph illustrating a method of compensating for the representative value of the partial areas according to an exemplary embodiment of the present invention;

FIG. 4 is a flowchart illustrating a method of adjusting the brightness according to an exemplary embodiment of the present invention;

FIG. 5 is a graph illustrating a method of lowering the representative value in order to reduce power needed for lighting the backlight according to another exemplary embodiment of the present invention;

FIG. 6 is a graph illustrating a method of compensating the brightness of image pixels according to another exemplary embodiment of the present invention; and

FIG. 7 is a flowchart illustrating a method of adjusting the brightness according to another exemplary embodiment of the present invention.

Throughout the drawings, the same drawing reference numerals will be understood to refer to the same elements, features, and structures.

### DETAILED DESCRIPTION OF EXEMPLARY EMBODIMENTS

Certain exemplary embodiments of the present invention will be described in greater detail with reference to the accompanying drawings.

The matters defined in the description such as detailed construction and element descriptions are provided to assist in a comprehensive understanding of the present invention. Accordingly, those of ordinary skill in the art will recognize that various changes and modifications of the embodiments described herein can be made without departing from the scope and spirit of the present invention. Also, well-known functions or constructions are omitted for clarity and conciseness.

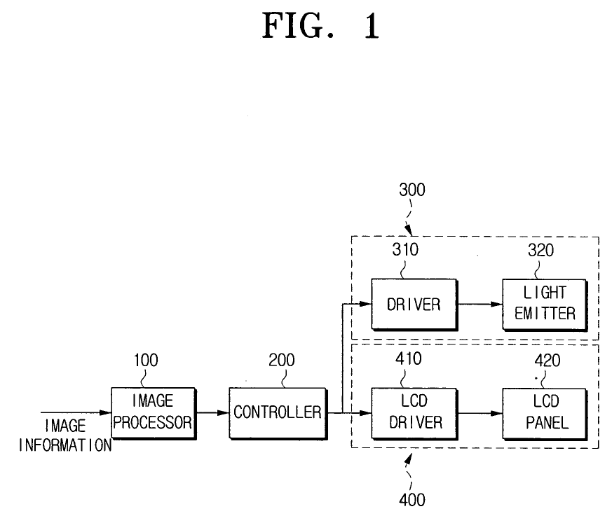

FIG. 1 is a schematic block diagram illustrating a structure of a liquid crystal display (LCD) according to an embodiment of the present invention. Referring to FIG. 1, an image processor 100 processes input image information to output image data which is divided into red, green and blue (R, G and B) signals to a controller 200.

The controller 200 calculates a representative value to be used for adjusting the brightness of each of the partial areas and outputs the representative value to a backlight unit 300. The backlight unit 300 comprises a driver 310, and a light emitter 320 in which the brightness of each of the partial areas can be adjusted.

The light emitter 320 comprises a plurality of luminous bodies and is divided into a predetermined number of partial areas. The plurality of luminous bodies can be luminescent diodes (LEDs) which are used as backlight sources in an LCD. However, the present invention is not limited to a backlight having luminescent diodes, but can be applied to any backlight, such as those using a cold cathode fluorescent lamp (CCFL), a field emission display (FED), a surface-conduction electron-emitter display (SED), or the like.

The predetermined number of partial areas are formed so as to partially control the brightness. For example, the light emitter 320 can be divided into 8×8 partial areas, thereby resulting in 64 total partial areas, so as to calculate and control the brightness of each of the partial areas.

The driver 310 is connected to the light emitter 320 to selectively control the brightness of each of the partial areas of the light emitter 320 using a pulse width modulation (PWM) method, a linear driving method, and so forth.

The controller 200 calculates the representative value for adjusting the brightness of each of the partial areas of the light emitter 320 in accordance with the image signal generated by the image processor 100.

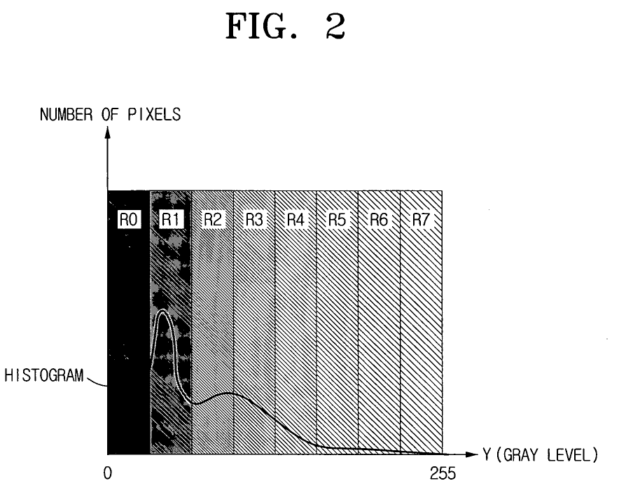

FIG. 2 is a histogram illustrating a method of calculating the representative value to be applied to each of the partial areas of the light emitter 320 in the controller 200 of the LCD illustrated in FIG. 1, according to an exemplary embodiment of the present invention.

Image pixels of each of the partial areas are classified into the number of pixels (along the vertical axis) according to gray levels (along the horizontal axis). For example, the number of pixels corresponding to each of the gray levels from “0” to “255” is extracted in order to create the histogram illustrated in FIG. 2. Here, it is preferable to take a maximum gray level among R, G, and B gray levels as in Equation (6) to determine a gray level of each of the image pixels from an input image signal:

Y=max(R,G,B) (6)

wherein Y denotes a gray level.

If the maximum gray level is not taken among the R, G, and B gray levels, color distortion may occur.

The gray levels (for example, from “0” to “255”) are divided into sections at predetermined intervals to calculate the representative value to be used for adjusting the brightness of each of the partial areas by using the number of pixels of each of the sections and a mean value of gray levels of each of the sections.

As shown in FIG. 2 for example, the gray levels are divided into eight sections from R0 to R7 to calculate the representative value to be used for adjusting the brightness of each of the partial areas. The representative value of each of the partial areas is calculated adopting the method illustrated in FIG. 2 by using Equation (1), repeated below.

$$L = f ( L\_Thr * ( {{N}_{0} ( \frac{{M}_{0}}{256} )}^{2} + {{N}_{1} ( \frac{{M}_{1}}{256} )}^{2} + {{N}_{2} ( \frac{{M}_{2}}{256} )}^{2} + {{N}_{3} ( \frac{{M}_{3}}{256} )}^{2} + {{N}_{4} ( \frac{{M}_{4}}{256} )}^{2} + {{N}_{5} ( \frac{{M}_{5}}{256} )}^{2} + {{N}_{6} ( \frac{{M}_{6}}{256} )}^{2} + {{N}_{7} ( \frac{{M}_{7}}{256} )}^{2} ) ) \qquad ( 1 )$$

wherein L_Thr denotes a coefficient for compensating the brightness of each of the partial areas, Mn(n=0, 1, 2, . . . ) denotes a mean value of gray levels (Y) of a section n, and Nn(n=0, 1, 2, . . . ) denotes the number of pixels of the section n.

Equation (1) allows the brightness to be adjusted mainly based on gray levels on which a large number of pixels of an image signal are positioned.

Typically, the calculated representative value must be compensated due to light loss caused by a correlation between neighboring partial areas. For example, if a dark image is a background as in a scene such as stars in the night sky or a fireworks display, light loss occurs in bright portions due to the dark background. Thus, the light loss is required to be compensated. The representative value is compensated using Equation (2), repeated below:

L′=L+BEN*(L−mean) (2)

wherein L′ denotes a new representative value of a partial area of which the brightness loss has been compensated, L denotes a representative value of the partial area of which the brightness loss has not been compensated, BEN denotes a coefficient for compensating for the brightness, and mean denotes a mean brightness of an entire input image.

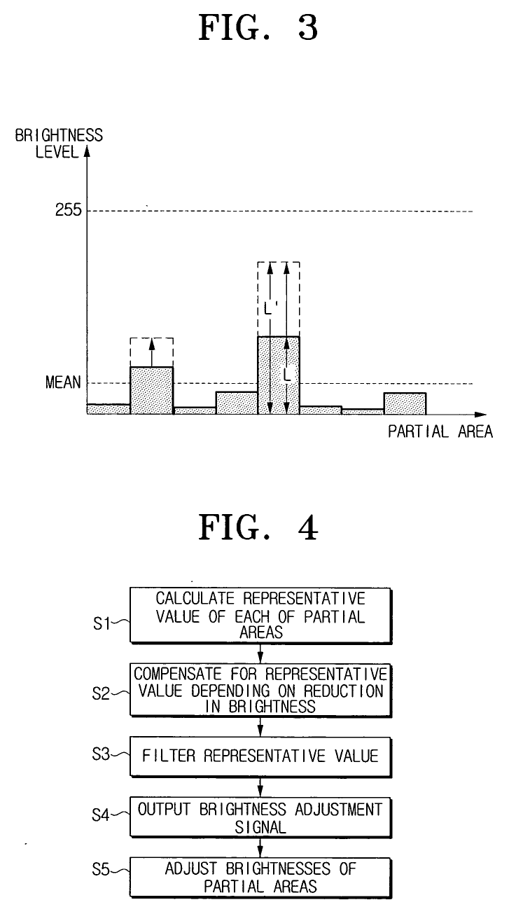

FIG. 3 is a graph illustrating a method of compensating for the representative value of a specific partial area using Equation (2). If the mean brightness (along the vertical axis) of an entire input image is lower than a predetermined threshold value (i.e., if the image is a dark image as a whole), a partial area (along the horizontal axis) of which a representative value is greater than the mean brightness of the entire input image is applied with a new representative value L′ which is compensated by using Equation (2) in order to adjust the brightness of the partial area.

The predetermined threshold value is a threshold value for a dark image and can be pre-set to a predetermined value, such as by using a manipulator. Also, a mean value of representative values of the partial areas can be used as a comparison reference value of a compensation condition instead of the mean brightness of the entire input image.

The controller 200 applies representative values calculated by Equation (2) to the partial areas to adjust the brightness of each of the partial areas, and uses a spatial filter and/or a temporal filter depending on the characteristics of an image.

For example, if a bright image is displayed in several partial areas of different sizes, since a representative value of each of the partial areas is calculated individually, the brightness difference between neighboring partial areas can be increased. Thus, a gray level difference may occur between partial areas. In this case, the spatial filter can be used to naturally represent the bright image in the neighboring partial areas.

Also, in the case of a moving picture having a temporally varying brightness, flickering of a backlight may occur due to abrupt increases in representative values of partial areas. In this case, the temporal filer can be adopted.

Generally, a low pass filter can be used as the spatial and temporal filters. The spatial and temporal filters are well known to those skilled in the art, and thus additional descriptions thereof will be omitted.

The controller 200 can adjust the brightness of a light emitter in synchronization with the input image at the same speed as a speed at which the input image signal is processed, or can adjust the brightness of the light emitter at a speed that is different from the speed at which the input image signal is processed. For example, if the brightness of the light emitter is more slowly adjusted than the input image signal, flickering as described above can be prevented.

FIG. 4 is a flowchart illustrating a method of adjusting the brightness of each of the partial areas according to an embodiment of the present invention. In step S1, a representative value of each of the partial areas of a light emitter is calculated. In step S2, the representative value is compensated in consideration of a reduction in the brightness. In step S3, the representative value is filtered to naturally represent a moving picture between neighboring partial areas. In step S4, the representative value is output as a brightness adjustment signal. In step S5, the brightness of each of the partial areas is adjusted based on the brightness adjustment signal.

A method of adjusting the brightness according to another embodiment of the present invention will now be described.

In accordance with another embodiment of the present invention, the representative value calculated as in the previous embodiment, can be spatial filtered using a non-linear spatial filter instead of the above-mentioned general spatial filter, to compensate for a gray level difference. This is because a low pass filter used as a general spatial filter extracts a signal having frequencies below a certain value and thus, may deteriorate a peak brightness. Thus, the filtering is performed with a maximum representative value maintained.

For example, if the filtering is performed using five taps L1, L2, L3, L4 and L5 which are sequentially arranged, a filtered brightness value of the current tap L3 can be determined by taking one maximum value among a value derived by multiplying a maximum value selected between the taps L2 and L4 by a predetermined filtering coefficient, a value derived by multiplying a maximum value selected between the taps L1 and L5 by a predetermined filtering coefficient, and a representative value of the current tap L3. Here, the predetermined filtering coefficients are values within a range between “0” and “1.”

The representative value to which spatial filtering has been applied can be reduced by a predetermined ratio R to reduce power needed for lighting the backlight. The predetermined ratio R can be calculated using Equation (3), repeated below:

R=A/(A+T_{—}Thr*(255−A)) (3)

wherein R denotes the predetermined ratio, A denotes a cut-off gray level, i.e., a maximum gray level of image pixels corresponding to each of the partial areas in which white Gaussian noise is excluded, and T_Thr denotes a predetermined threshold value within a range between “0” and “1.” Here, the maximum gray level A satisfies Equation (4), repeated below:

$${\sum }_{g = 0}^{A} H ( g ) \geq Cut\_Thr , and {\sum }_{g = 0}^{A - 1} H ( g ) < Cut\_Thr \qquad ( 4 )$$

wherein g denotes a gray level, H(g) denotes a total number of pixels corresponding to “0” through “g”, and Cut_Thr denotes a predetermined threshold value allowing a large number of pixels to belong to gray levels “0” through “A.”

Preferably, the value A is a gray level which must satisfy Equation (4), i.e., a maximum value of gray levels of a corresponding partial area excluding white Gaussian noise. As noted in Equations (3) and (4), the predetermined ratio R for lowering a representative value of a partial area can be determined in relation with gray levels of image pixels.

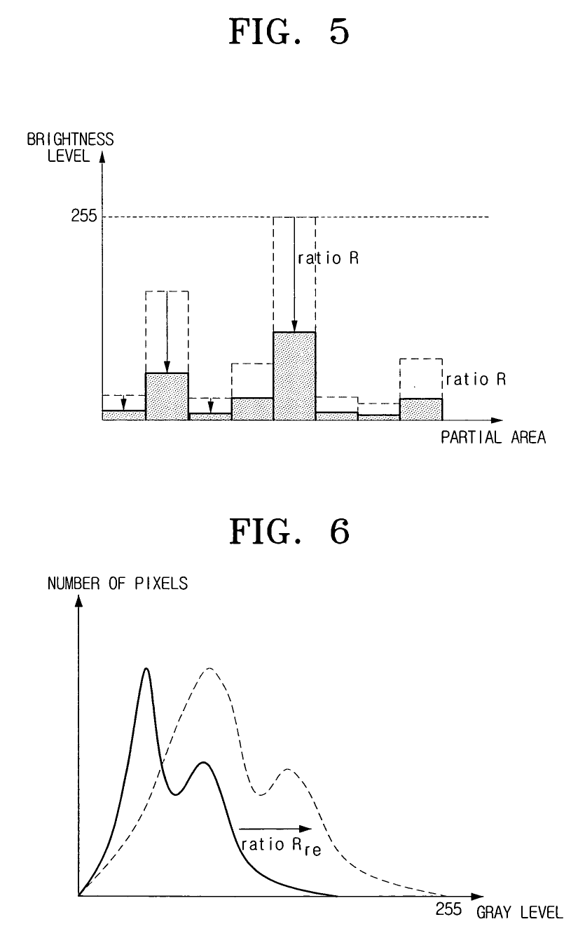

FIG. 5 is a graph illustrating a method of lowering a spatial filtered representative value by a predetermined ratio R determined using the Equations described above. Thus, the brightness level (along the vertical axis) of each of the partial areas (along the horizontal axis) is lowered due to a reduction of the representative value, thereby resulting in economy of power needed for lighting the light emitter.

Also, the lowered representative value can be temporal filtered using Equation (5), repeated below:

Lₒᵤₜ⁽ⁿ⁾(k)=P′·L_{ST}⁽ⁿ⁾(k)+(1−P′)·Lₒᵤₜ⁽ⁿ⁻¹⁾(k) (5)

wherein P′ denotes a predetermined threshold value for filtering and P′=min(P+S, 1), where P=|Mean_P−Mean_C|/256 and S=|Mean_P−Mean_C|/256, Lₒᵤₜ⁽ⁿ⁾(k) denotes the final output brightness of a k^{th} partial area of a current frame after filtering, L_{ST}⁽ⁿ⁾(k) denotes the brightness of the k^{th} partial area of the current frame, Lₒᵤₜ⁽ⁿ⁻¹⁾(k) denotes the final output brightness of a k^{th} partial area of a previous frame, P denotes frame brightness variation, S denotes a partial area's brightness variation, Mean_P denotes the mean brightness of pixels of the previous frame, and Mean_C denotes the mean brightness of pixels of the current frame.

In contrast with conventional temporal filtering, since the predetermined threshold value P′ is “1” or less, the temporal filtering according to embodiments of the present invention can be advantageously applied to images which have great brightness differences between a previous frame and a current frame, as when a scene is changed from daytime to nighttime.

Also, the controller 200 can adjust the brightness of image pixels corresponding to each of the partial areas of the backlight unit 300 to compensate for the brightness of the partial area lowered by the predetermined ratio R to reduce power needed for lighting the backlight.

FIG. 6 is a graph illustrating a method of compensating the brightness of image pixels corresponding to each of the partial areas. A value Rᵣₑ used for compensation uses a predetermined ratio R calculated to reduce power needed for lighting the backlight. Here, the brightness of the image to be displayed is adjusted by multiplying each of the gray levels (along the horizontal axis) of a partial area (along the vertical axis) by “1/R” or “(1/R)^{1/γ}(γ>1)” depending on a relationship between a gray level of a pixel and a brightness to be displayed. That is, the multiplication of the gray level by “(1/R)^{1/γ}” is suitable when gamma compensation is performed.

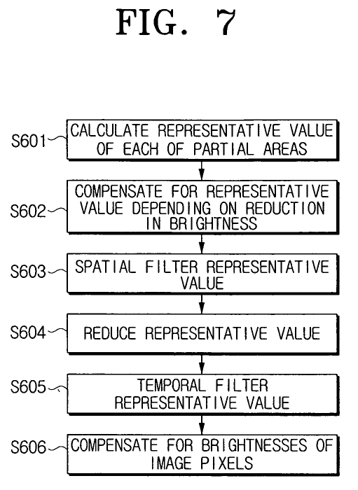

FIG. 7 is a flowchart illustrating a method of adjusting the brightness of an LCD according to another embodiment of the present invention. In step S601, a representative value of each of the partial areas of a backlight is calculated. In step S602, the calculated representative value is compensated in consideration of a reduction in brightness. In step S603, the representative value is spatial filtered. In step S604, the spatial filtered representative value is lowered by a predetermined ratio to reduce power needed for lighting the backlight. In step S605, the lowered representative value is temporal filtered and output to the backlight unit 300.

In step S606, the brightness of image pixels corresponding to each of the partial areas of the backlight are compensated to compensate for a brightness of each of the partial areas of the backlight lowered by the predetermined ratio R.

The image signal for the image pixels of which the brightness has been compensated is then output to an LCD unit 400 to be displayed on an LCD panel 420 via an LCD driver 410. Here, the predetermined ratio R is used to compensate for the brightness of the image pixels.

As described above, in such an LCD and method of adjusting the brightness for the LCD according to embodiments of the present invention, the brightness of each of the partial areas of a backlight can be adjusted in accordance with an input image signal. Thus, a contrast ratio can be improved. Also, a representative value to be used for adjusting the brightness of each of the partial areas can be lowered by a predetermined ratio so as to effectively reduce power needed for lighting the backlight.

In addition, light loss and light gain occurring between neighboring partial areas can be compensated to improve the contrast ratio. Moreover, image artifacts can be reduced.

The foregoing embodiments and advantages are merely exemplary and are not to be construed as limiting the present invention. The present exemplary embodiments can be readily applied to other types of apparatuses. Also, the description of the embodiments of the present invention is intended to be illustrative, and not to limit the scope of the claims, and many alternatives, modifications, and variations will be apparent to those skilled in the art without departing from the spirit and scope of the invention as defined by the appended claims and the full scope of equivalents thereof.

What is claimed is:

1. An LCD (liquid crystal display), comprising:
a light emitter comprising a plurality of luminescent bodies divided into a predetermined number of partial areas;
a backlight driver connected to the light emitter for controlling a brightness of each of the partial areas of the light emitter; and
a controller for calculating a representative value for adjusting the brightness of each of the partial areas of the light emitter in accordance with an input image signal and outputting the representative value as a brightness adjustment signal for adjusting the brightness of each of the partial areas to the backlight driver.

2. The LCD of claim 1, wherein the controller is configured to filter and output the brightness adjustment signal.

3. The LCD of claim 2, wherein the controller is configured to filter and output the brightness adjustment signal using at least one of spatial filtering and temporal filtering.

4. The LCD of claim 1, wherein the controller is configured to:
classify pixels of each of the partial areas into a number of pixels according to each gray level in accordance with an input image signal; and
calculate the representative value to be used to adjust the brightness of each of the partial areas by using the number of pixels of each of sections which are made by dividing gray levels at predetermined intervals and a mean value of the gray levels of each section.

5. The LCD of claim 4, wherein the representative value is calculated using the equation:
$$L = f ( L\_Thr * ( {{N}_{0} ( \frac{{M}_{0}}{256} )}^{2} + {{N}_{1} ( \frac{{M}_{1}}{256} )}^{2} + {{N}_{2} ( \frac{{M}_{2}}{256} )}^{2} + {{N}_{3} ( \frac{{M}_{3}}{256} )}^{2} + {{N}_{4} ( \frac{{M}_{4}}{256} )}^{2} + {{N}_{5} ( \frac{{M}_{5}}{256} )}^{2} + {{N}_{6} ( \frac{{M}_{6}}{256} )}^{2} + {{N}_{7} ( \frac{{M}_{7}}{256} )}^{2} ) )$$
wherein L_Thr denotes a coefficient for compensating brightness of each of the partial areas, Mn(n=0, 1, 2, . . . ) denotes a mean value of the gray levels of a section n, and Nn(n=0, 1, 2, . . . ) denotes a number of pixels of the section n.

6. The LCD of claim 5, wherein if a mean brightness of the entire input image signal is lower than a predetermined threshold value, a partial area of which the representative value is greater than the mean brightness of the entire input image is applied with a new representative value L′ which has been compensated in order to adjust the brightness of the partial area using the equation:
L′=L+BEN*(L−mean)
wherein L′ denotes a new representative value of a partial area of which brightness loss has been compensated, L denotes a representative value before being compensated, BEN denotes a coefficient for compensating for the brightness, and mean denotes a mean brightness of an entire input image.

7. The LCD of claim 1, wherein the controller is configured to adjust the brightness of the light emitter at a speed substantially the same as a speed at which the input image signal is processed in synchronization with the input image signal.

8. The LCD of claim 1, wherein the controller is configured to adjust the brightness of the light emitter at a speed different from a speed at which the input image signal is processed.

9. A method of adjusting the brightness for an LCD, comprising:
calculating a representative value for adjusting brightness of each of partial areas of a light emitter in accordance with an input image signal;
outputting the calculated representative value as a brightness adjustment signal; and
adjusting the brightness of each of the partial areas based on the brightness adjustment signal.

10. The method of claim 9, further comprising filtering and outputting the brightness adjustment signal.

11. The method of claim 9, wherein the calculating of the representative value for adjusting the brightness of each of the partial areas of the light emitter in accordance with the input image signal comprises:
classifying pixels of each of the partial areas into a number of pixels according to each gray level in accordance with the input image signal; and
calculating the representative value to be used to adjust the brightness of each of the partial areas by using the number of pixels of each of sections which are made by dividing the gray levels at predetermined intervals and a mean value of the gray levels of each section.

12. The method of claim 11, wherein the representative value is calculated using the equation:
$$L = f ( L\_Thr * ( {{N}_{0} ( \frac{{M}_{0}}{256} )}^{2} + {{N}_{1} ( \frac{{M}_{1}}{256} )}^{2} + {{N}_{2} ( \frac{{M}_{2}}{256} )}^{2} + {{N}_{3} ( \frac{{M}_{3}}{256} )}^{2} + {{N}_{4} ( \frac{{M}_{4}}{256} )}^{2} + {{N}_{5} ( \frac{{M}_{5}}{256} )}^{2} + {{N}_{6} ( \frac{{M}_{6}}{256} )}^{2} + {{N}_{7} ( \frac{{M}_{7}}{256} )}^{2} ) )$$
wherein L_Thr denotes a coefficient for compensating for brightness of each of the partial areas, Mn(n=0, 1, 2, . . . ) denotes a mean value of the gray levels of a section n, and Nn(n=0, 1, 2, . . . ) denotes a number of pixels of the section n.

13. The method of claim 12, further comprising:
if a mean brightness of the entire input image signal is lower than a predetermined threshold value, compensating for brightness loss of a partial area of which the representative value is greater than the mean brightness of the entire input image by using the equation:
L′=L+BEN*(L−mean)
wherein L′ denotes a new representative value of a partial area of which brightness loss has been compensated, L denotes a representative value before being compensated, BEN denotes a coefficient for compensating for the brightness, and mean denotes a mean brightness of an entire input image.

14. The method of claim 9, wherein the brightness of the light emitter is adjusted at a speed substantially the same as a speed at which the input image signal is processed in synchronization with the input image signal.

15. The method of claim 9, wherein the brightness of the light emitter is adjusted at a speed different from a speed at which the input image signal is processed.

16. An LCD, comprising:
a backlight unit comprising a light emitter divided into a predetermined number of partial areas which are configured so that the brightness of each of the partial areas can be adjusted;
an LCD unit comprising an LCD panel and an LCD driver; and
a controller for calculating a representative value to be used for adjusting the brightness of each of the partial areas in accordance with an input image signal, lowering the representative value by a predetermined ratio to reduce power consumption of the backlight unit, and outputting the lowered representative value to the backlight unit.

17. The LCD of claim 16, wherein the predetermined ratio is calculated using the equation:
R=A/(A+T_{—}Thr*(255−A))
wherein R denotes the predetermined ratio, A denotes a cut-off gray level, and T_Thr denotes a predetermined threshold value within a range between “0” and “1.”

18. The LCD of claim 17, wherein the cut-off gray level A denotes a maximum gray level of image pixels corresponding to a partial area wherein white Gaussian noise is excluded.

19. The LCD of claim 17, wherein the cut-off gray level A satisfies the equation:
$${\sum }_{g = 0}^{A} H ( g ) \geq Cut\_Thr , and {\sum }_{g = 0}^{A - 1} H ( g ) < Cut\_Thr$$
wherein g denotes a gray level, H(g) denotes a total number of pixels corresponding to “0” through “g”, and Cut_Thr denotes a predetermined threshold value allowing a large number of pixels to belong to gray levels “0” through “A.”

20. The LCD of claim 19, wherein the controller is configured to multiply gray levels of image pixels corresponding to each of the partial areas by at least one of values “1/R” and “(1/R)^{1/γ}” to compensate for the reduction in the brightness of the backlight unit caused by the lowered representative value so that the brightness of an image to be displayed can be adjusted.

21. The LCD of claim 16, wherein the controller is configured to perform spatial filtering of the representative value to maintain the brightness of the partial area of which the brightness is the maximum among the partial areas.

22. The LCD of claim 16, wherein the controller performs temporal filtering of the representative value using the equation:
Lₒᵤₜ⁽ⁿ⁾(k)=P′·L_{ST}⁽ⁿ⁾(k)+(1−P′)·Lₒᵤₜ⁽ⁿ⁻¹⁾(k)
wherein P′ denotes a predetermined threshold value for filtering and P′=min(P+S, 1), where P=|Mean_P−Mean_C|/256 and S=|Mean_P−Mean_C|/256, Lₒᵤₜ⁽ⁿ⁾(k) denotes a final output brightness of a k^{th} partial area of a current frame after filtering, L_{ST}⁽ⁿ⁾(k) denotes a brightness of the k^{th} partial area of the current frame, Lₒᵤₜ⁽ⁿ⁻¹⁾(k) denotes a final output brightness of a k^{th} partial area of a previous frame, P denotes frame brightness variation, S denotes a partial area's brightness variation, Mean_P denotes a mean brightness of pixels of the previous frame, and Mean_C denotes a mean brightness of pixels of the current frame.

23. A method of adjusting the brightness for an LCD, comprising:
calculating a representative value for adjusting brightness of each of partial areas of a light emitter in accordance with an input image signal;
lowering the representative value by a predetermined ratio to reduce power consumption of a backlight unit; and
outputting the lowered representative value to the backlight unit to apply the lowered representative value to adjust the brightness of each of the partial areas.

24. The method of claim 23, wherein the predetermined ratio is calculated using the equation:
R=A/(A+T_{—}Thr*(255−A))
wherein R denotes a predetermined ratio, A denotes a cut-off gray level, and T_Thr denotes a predetermined threshold value within a range between “0” and “1.”

25. The method of claim 24, wherein the cut-off gray level A is a maximum gray level of image pixels corresponding to a partial area wherein white Gaussian noise is excluded.

26. The method of claim 24, wherein the cut-off gray level A satisfies the equation:
$${\sum }_{g = 0}^{A} H ( g ) \geq Cut\_Thr , and {\sum }_{g = 0}^{A - 1} H ( g ) < Cut\_Thr$$
wherein g denotes a gray level, H(g) denotes a total number of pixels corresponding to “0” through “g”, and Cut_Thr denotes a predetermined threshold value allowing a large number of pixels to belong to gray levels “0” through “A.”

27. The method of claim 26, further comprising multiplying gray levels of image pixels corresponding to each of the partial areas by at least one of values “1/R” and “(1/R)^{1/γ}” to adjust the brightness of an image to be displayed to compensate for the reduction in the brightness of the backlight unit caused by the lowered representative value.

28. The method of claim 23, further comprising spatial filtering the representative value to maintain the brightness of the partial area of which the brightness is the maximum among the partial areas.

29. The method of claim 23, further comprising temporal filtering the representative value using the equation:
Lₒᵤₜ⁽ⁿ⁾(k)=P′·L_{ST}⁽ⁿ⁾(k)+(1−P′)·Lₒᵤₜ⁽ⁿ⁻¹⁾(k)
wherein P′ denotes a predetermined threshold value for filtering and P′=min(P+S, 1), where P=|Mean_P−Mean_C|/256 and S=|Mean_P−Mean_C|/256, Lₒᵤₜ⁽ⁿ⁾(k) denotes a final output brightness of a k^{th} partial area of a current frame after filtering, L_{ST}⁽ⁿ⁾(k) denotes a brightness of the k^{th} partial area of the current frame, Lₒᵤₜ⁽ⁿ⁻¹⁾(k) denotes a final output brightness of a k^{th} partial area of a previous frame, P denotes frame brightness variation, S denotes a partial area's brightness variation, Mean_P denotes a mean brightness of pixels of the previous frame, and Mean_C denotes a mean brightness of pixels of the current frame.
